(19) United States
(12) Patent Application Publication
(10) Pub. No.: US 2009/0006622 A1
(43) Pub. Date: Jan. 1, 2009

(54) Ultimate client development system

(76) Inventor: William Doerr, Kensington, CT (US)

Correspondence Address: Robert L. Rispoli;Clayman, Tapper & Baram, LLC, 3 Regency Drive, Bloomfield, CT, 06002, US

(21) Appl. No.: 12/215,636

(22) Filed: Jun. 27, 2008

Related U.S. Application Data
(60) Provisional application No. 60/937,419, filed on Jun. 27, 2007.

(51) Int. Cl. G06F 15/173

(52) U.S. Cl. 709/225

(57) ABSTRACT

A client development system is provided that includes creating a plurality of hosts and host databases. A host contact is identified, qualified, and cultivated. The system provides for three levels of users: hosts, experts, and members. The system permits a host's member contacts and experts to search the expert directories of other hosts for an expert that matches a particular profile. The system also provides automatic communications to a host contact from the host as well as and other contact interface notifications for the host.

### CROSS-REFERENCE TO RELATED APPLICATION

This application claims the benefit of U.S. Provisional Application No. 60/937,419 filed Jun. 27, 2007.

### BACKGROUND OF THE INVENTION

1. Field of the Invention

The present invention is directed to a methodology and online system designed to help a user process a potential client for the user's services, or a potential center-of-influence (“COI”) for the user, from an initial contact to an ultimate disposition. In particular, the present invention comprises a comprehensive client development system. More particularly, the client development system of the present invention comprises a process for identifying one user's needs and another user's problem-solving capabilities, process steps for contacting such users, qualifying need and skills, cultivating potential clients, and ultimate disposition of the initial contact.

2. Brief Description of the Related Art

There are various social networking services known in the art that use software to build online social networks for communities of people who share common interests and activities. Most services are primarily web-based and provide a collection of various methods for users to interact. Social networking has revolutionized the way we communicate and share information with one another in today's society. Various social networking websites are being used by millions of people everyday on a regular basis and it now seems that social networking is a part of everyday life.

The main types of social networking services are those which contain directories of some categories (such as former classmates), means to connect with friends (usually with self-description pages), and recommendation systems linked to trust. Early social networking websites included Classmates.com, focusing on ties with former school classmates, and SixDegrees.com, focusing on indirect ties. User profiles could be created, messages sent to users held on a “friends list,” and other members that had similar interests to yours in their profiles could be reached. In 2007, Facebook™ began allowing externally-developed add-on applications, and some applications enabled the graphing of a user's own social network, thus linking social networks and social networking.

Social networking has begun to flourish as a component of business internet strategy. It is estimated that there are now over 200 social networking sites using these existing and emerging social networking models. Social networks connect people at low cost; this can be beneficial for entrepreneurs and small businesses looking to expand their contact base. These networks often act as a customer-relationship management tool for companies selling products and services. Companies can also use social networks for advertising in the form of banners and text ads. Since businesses operate globally, social networks can make it easier to keep in touch with contacts around the world.

An example of social networking known in the art and used for business purposes is LinkedIn.com. It is a social networking site with the aim of connecting people who know each other together online. It has become one of the most widely recognized professional networking sites, with more than 20 million registered users from 150 different industries. The purpose of the site is to allow registered users to maintain a list of people they know and trust. The people in a user's list are called Connections. Users can invite anyone (whether a site user or not) to become a connection. This list of connections can then be used in a number of ways:
A contact network is built up consisting of a user's direct connections (“first degree contacts”), the connections of their connections (“second degree contacts”), and also the connections of second degree connections (“third degree contacts”). This contact network can then be used to gain an introduction to anyone you wish to know in that contact network.
The network can then be used to find jobs, people and business opportunities recommended by someone in one's contact network.
Employers can list jobs and search for potential candidates.
Job seekers can review the profile of hiring managers and discover which of their existing contacts can introduce them.

The “gated-access approach” (where contact with any connection requires either a preexisting relationship or the intervention of a first degree contact of theirs) is intended to reflect trust among the service's users.

U.S. Patent Application Publication No. US2008/059576 describes a social network that identifies users who are related to a target by no more than a set maximum degree of separation. The system starts with the contacts of the target and then identifies users that are contacts of that target. The system continues the process of identifying contacts of contacts until the maximum degree of separation is reached. The potential contacts are ranked and then presented to the initial user.

Professional networking sites can also function as online meeting places for business and industry professionals. Virtual communities for businesses allow individuals to be accessible to one another. People establish their real identity in a verifiable place. These individuals then interact with each other or within groups that share common business interests and goals. A professional network may be used for the business-to-business marketplace. These networks improve the ability of people to connect with others and, as a result, advance their careers or personal interests. Business professionals can share experiences with others who have a need to learn from similar experiences. Additionally, the ability to find, connect and network with other business professionals is one reason why these social networks are so popular. The traditional way to interact is face-to-face. Interactive technology makes it possible for people to network with their peers from anywhere, at anytime, in an online environment. Professional network services attract, aggregate and assemble large business-focused audiences by creating informative and interactive meeting places.

In general, social networking services allow users to create a profile for themselves, and can be broken down into two broad categories: internal social networking (ISN) and external social networking (ESN) sites, such as MySpace™, Facebook™ and Bebo™. Both types can increase the feeling of community among people. An ISN is a closed/private community that consists of a group of people within a company, association, society, education provider and organization or even an “invite only” group created by a user. An ESN is open/public and available to all web users to communicate and are designed to attract advertisers. ESNs can be smaller specialized communities (i.e. linked by a single common interest) or they can be large generic social networking sites like MySpace™ and Facebook™. However, whether specialized or generic, social networking sites share certain characteristics in common. Users can upload a picture of themselves, create their “profile”, and often can be “friends” with other users. In most social networking services, both users must confirm that they are friends before they are linked or ‘connected’.

A reputation system is a type of collaborative filtering algorithm which attempts to determine ratings for a collection of entities, given a collection of opinions that those entities hold about each other. This is similar to a recommendation system, but with the purpose of entities rating other parties, rather than some external set of entities (such as books, movies, or music). Reputation systems are often useful in large online communities in which users may frequently have the opportunity to interact with users with whom they have no prior experience or in communities where user-generated content is posted. In such a situation, it is often helpful to base the decision whether or not to interact with that user on the prior experiences of other users.

The Internet, and specifically social networks and social networking, provide the underlying infrastructure and the potential to track a referral and its path in the network, and to keep all parties updated with respect to the referral progress.

Even with all of the social networks known in the art, a need still exists to efficiently and effectively connect a first user with a second user who is being cultivated by the first user for that user's value as a prospective client or center-of-influence in a business-to-business environment, where the two users may also refer each other to still other connections who are trusted and qualified experts for particular services. The first and second user should be able to establish a reciprocal referral relationship whereby they leverage their influence and prestige with other people they both know in common on behalf of one another. There also is a need to help users generate contacts from, and make introductions to, key people for their business or professional practice. Finally, a need exists to help users make keeping-in-touch with prospects, clients and centers-of-influence for their business a simple task.

It is an object of the present invention to overcome the shortcomings of the prior art stated above. It is another object of the present invention to provide a mechanism that incorporates and coordinates two different and unique services and one personal prospecting system into one, unified and coherent online system in order to foster the development of personal relationships for a business or professional practice as well as the revenues they suggest for a client development system user.

### DESCRIPTION OF THE INVENTION

The method and system of the present invention describes a client development system designed to help a service provider process a candidate for his or her services or a center-of-influence from an initial contact to an ultimate disposition. The invention combines the services of The Expert Directory® and The Client Machine® with that of The Preferral Prospecting System®, all registered trademarks of SellMore Marketing, LLC of Connecticut, into one, unified and coherent online system. Through the use of four distinct functions (Prospecting, Qualifying, Cultivating, and Converting), the present invention creates a unique and novel networking environment for use online.

### BRIEF DESCRIPTION OF THE DRAWINGS

FIG. 1 provides a flow diagram that illustrates the overall process of actions that may occur within a client development system according to the present invention.

FIG. 2 provides a flow diagram illustrating the three (3) main sources of Contacts that become part of a client development system Host's database.

FIG. 3 provides a diagram that illustrates the three (3) types or categories of Contacts that may exist in a client development system Host's database.

FIG. 4 provides a diagram that illustrates the processing of a Member's request of Expert Directories available to a Member from 1st degree Hosts.

FIG. 5 provides a diagram that illustrates the processing of a Contact into a Host's database for purposes of ‘cultivation’ by periodic, permissioned emails.

FIG. 6 provides a diagram that illustrates the four (4) ways a Contact can enter a Host's database; and the six types of Output of the client development system.

FIG. 7 provides a diagram that illustrates how a Contact can enter a Host's Expert Directory database.

### DETAILED DESCRIPTION OF THE INVENTION

In a system according to the present invention, a principal user of the system (a “Host”), other users (“Members”) who are persons being cultivated by a Host for future business, and persons who are experts in a user's Directory (“Experts”) may be introduced to other Hosts, Members, and Experts up to and including third degree connections or contacts of any Host, through the influence and prestige of people they both know in common. The present invention also provides a means for Hosts, Members, and Experts to generate connections from, and make introductions to, key people for their business or professional practice. In addition, the present invention provides a simple means for keeping-in-touch with prospects, clients and centers-of-influence who are first degree connections of a system Host.

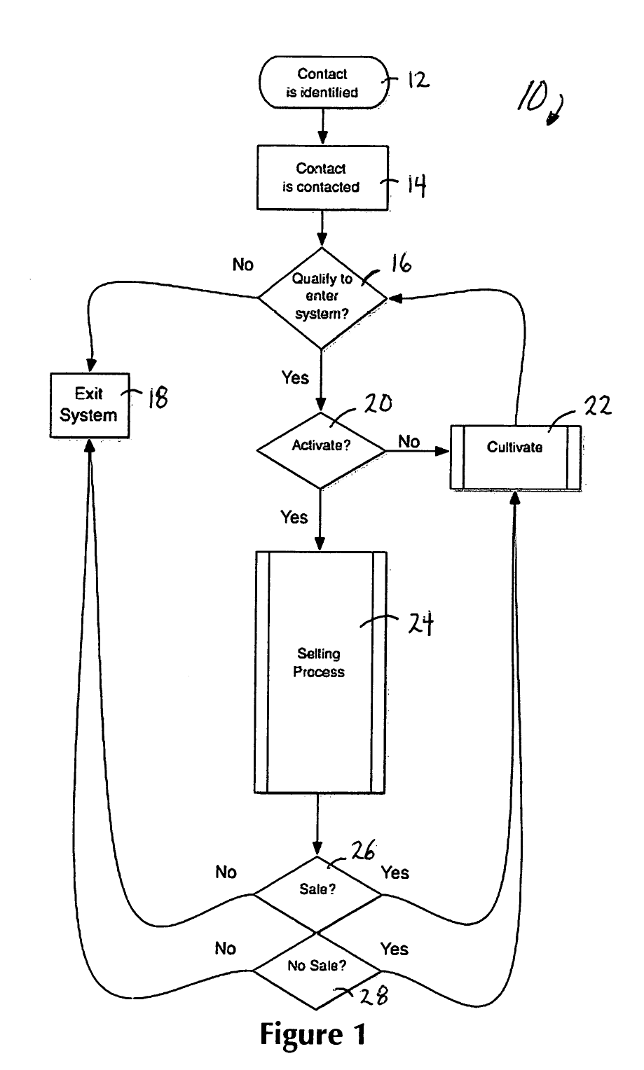

A client development system in accordance with the present invention comprises Initial Entry, Administrative Activity, Contacting and Qualifying, Cultivating, Selling, and the resultant data feedback into the system. As shown in FIG. 1, a client development system 10 in accordance with the present invention comprises the steps of identifying a Contact 12 followed by contacting that Contact 14. A decision 16 is made with respect to the qualifications of the Contact to be entered into the system. If the decision is No, the Contact is not placed in the system and exits the system 18. If the decision is Yes, the Contact is passed to the next decision step: Activate 20.

If the decision to Activate is No, the Contact is placed in Cultivate 22 status, and may be further qualified as indicated. If the decision to Activate is Yes, the Host and the Contact enter the Selling Process 24. Whether or not the Selling Process 24 results in a Sale 26 or No Sale 28, the Contact, at the Host's discretion, may be placed in Cultivate 22 status or simply Exit the System 18.

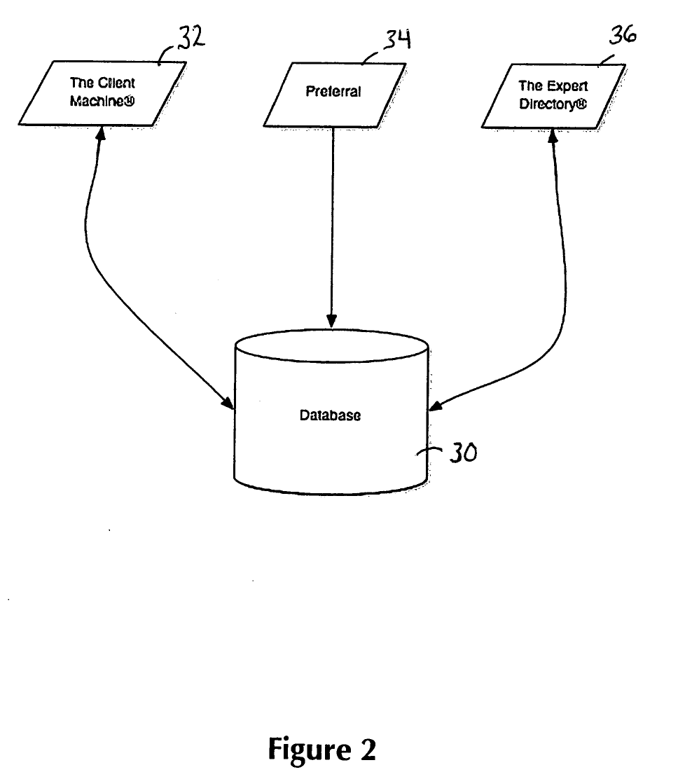

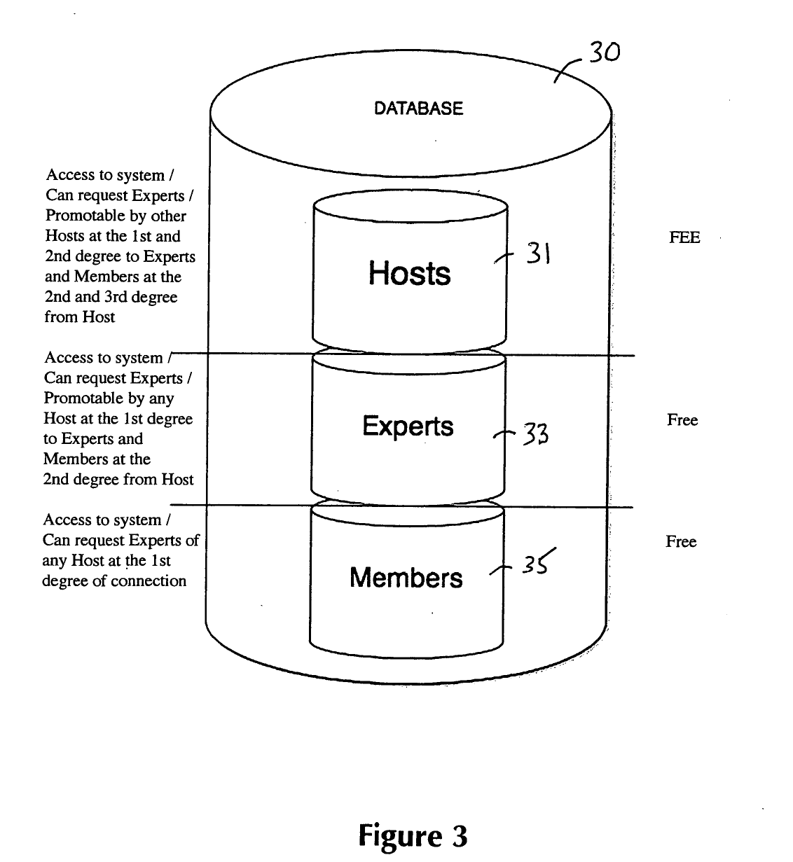

As shown in FIG. 2, the three (3) main sources of Contacts that become part of a client development system Host's database 30 are The Client Machine® 32, as a Preferral 34, or via The Expert Directory® 36. As shown in FIG. 3, a Contact may exist in a client development system Host's database 30 in one of three access levels: Hosts 31; Experts 33, and Members 35. Typically, access would be provided for no fee for Experts 33 and Members 35, and for a fee for Hosts 31. Members 35 would be provided with access to the system and may request a listing of Experts of any Host 31 at the first degree of connection. Experts 33 would be provided with access to the system and may request a listing of other Experts 33, or themselves be promoted as an Expert 33, for any request of a listing of any Host 31 at the first degree of connection to Experts 33, and Members 35 at the second degree of connection to the Host. Lastly, Hosts 31 are provided access to the system and can request a listing of Experts 33 or be promotable by other Hosts 31 at the first and second degree of connection to Experts 33 and Members 35 at the second and third degree of connection from a Host 31.

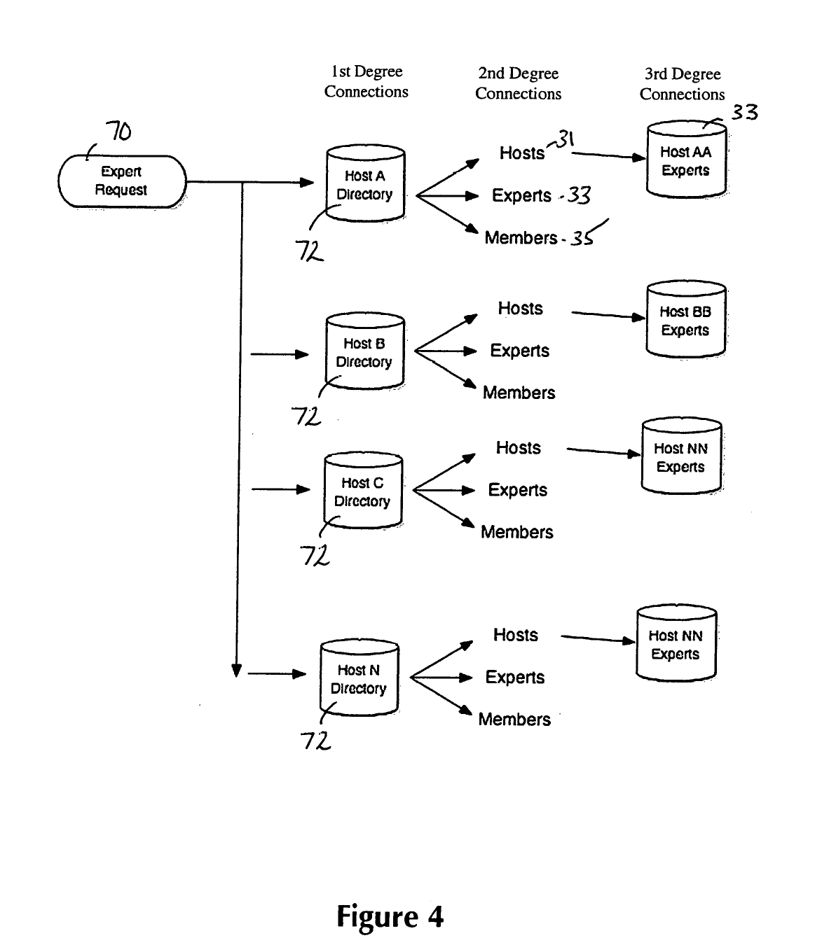

A request for an Expert 33, allows a Member 35 to reach as far as a third degree connection from themselves as shown in FIG. 4. When requesting an Expert 33, a third degree connection can be found because of the client development system's capability to include first and second degrees connections of first degree Hosts 31 that are being used to process/initiate an Expert Request 70. As further shown in FIG. 4, Expert Request 70 reaches first degree connection Host's Directories 72. In turn, the Expert Request 70 reaches the Hosts 31, Experts 33 and Members 35 of the first degree of connection Host's Directories 72. Lastly, the Expert Request 70 reaches the second degree of connections Host's Experts 33.

As a result of the process illustrated in FIG. 4, Members 35 may initiate Expert Requests 70 with any first degree connections they have who are Hosts 31 of an Expert Directory 36. After defining (profiling) the kind of Expert 33 a Member 35 is seeking, the system searches the Expert Directory 36 of any first degree connections of the Member 35 who are Hosts 31 as well as the Expert Directory 36 of any Hosts 31 who are second degree connections of the Member 35 for possible matches of Experts 33 who satisfy the requirements of the profile chosen by the Member 35. Finally, any qualified Experts 33 who satisfy the profile created by the Member 35 in an Expert Directory 36 of a second degree connection of a Member 35 requesting an Expert 33 are revealed generically to the first degree connection Host 31 and specifically to the second degree connection Host 31. This prompts a discussion between the first and second degree connection Hosts to make a decision to reveal the qualified Expert(s) of the second degree connection Host(s) and the first degree connection Host(s) involved so that any qualified Experts can be revealed to the Member who requested an Expert in the first place.

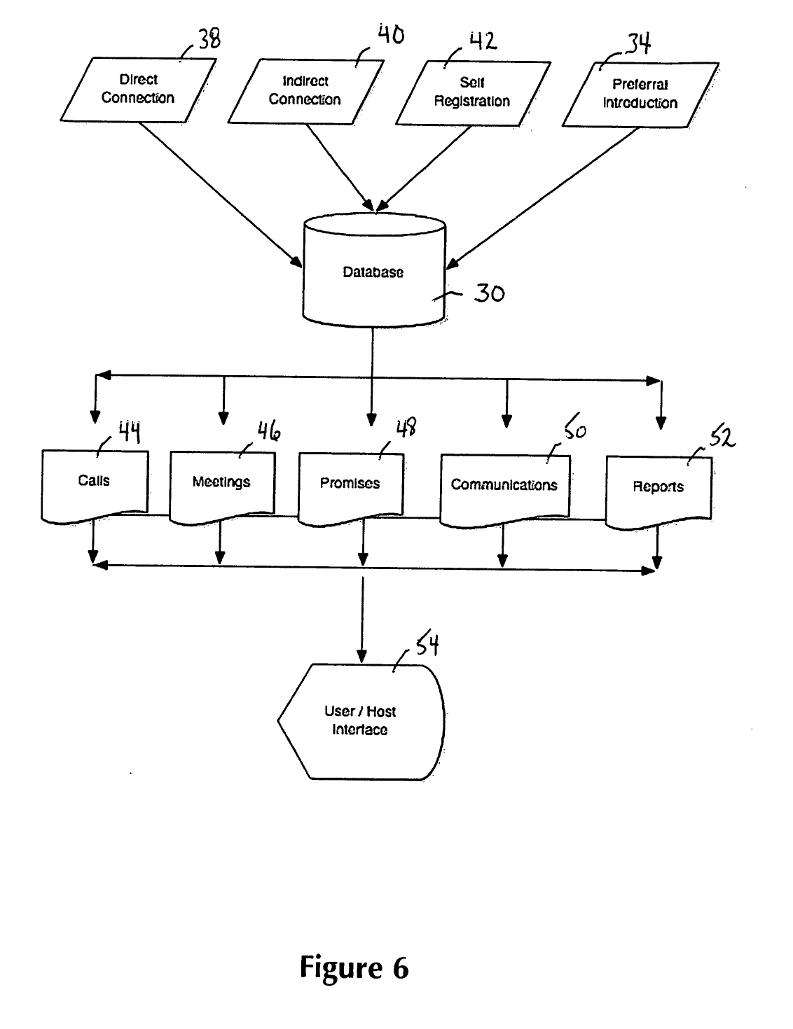

Initial Entry into a Host's database 30 as a Member may occur by any of four (4) paths as shown in FIG. 6. A person may be entered into the directory as a result of:
1. a Preferral 34 (Preferred Introduction) to the Host from a COI;
2. a Direct Connection 38 between the Host and the Member;
3. an Indirect Connection 40 between the Member and the Host; or
4. a Member may be entered into the directory not by a Host, but as a result of Self Registration 42 by a Member, online through the Expert Directory.

In the first case, a Host learns about an individual (a Member) from someone they know in common, such as a COI. In this case, the Host would contact that individual either by letter or by telephone at a time convenient to the Host. In the second case, a Host learns about an individual (a Member) through a direct contact of some kind, such as meeting them at a Chamber of Commerce meeting, a member—guest golf tournament, a seminar or workshop, a church picnic, etc. In the third case, a Host learns about an individual (a Member) as a result of a non-personal or indirect connection such as from a list of contacts purchased from a list company, a list of trade association members in a membership directory, etc.

In the fourth case, an individual (a Member) would self-register online with the HOST after one of the following events:
1. The person responds to an email inviting them to join the Host's online Expert Directory; or
2. The person registers online after initiating a visit to the Host's website and/or online Expert Directory.

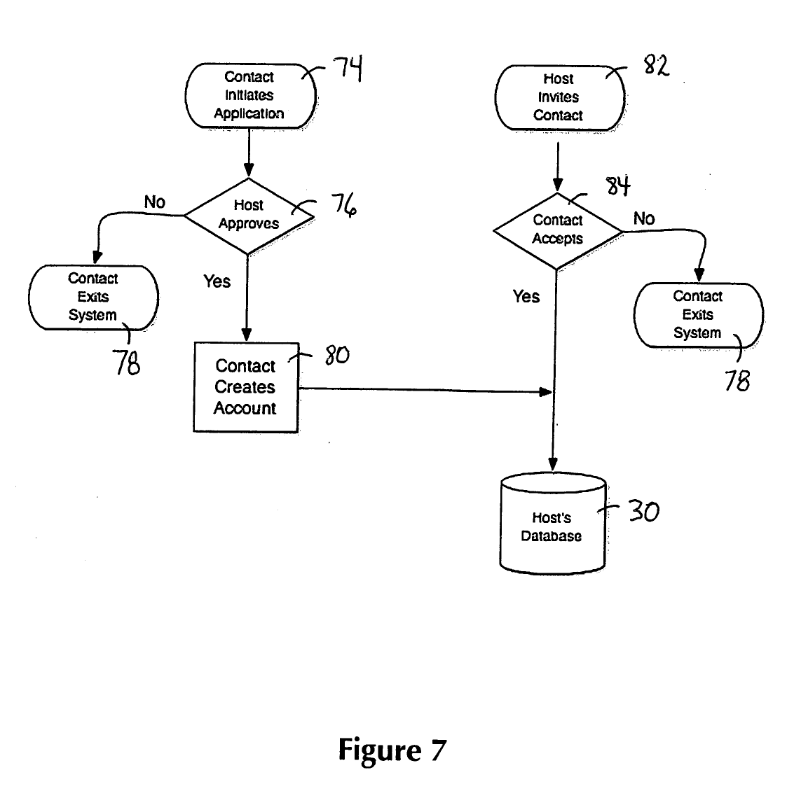

As further shown in FIG. 7, a Contact may initiate an Application 74 into a Host's database 30, and the Host makes a Decision 76 to accept or decline the Application. If the Application is declined, the Contact Exits the System 78. If the Application is approved, a Contact Account 80 is created and the Contact is entered into the Host's database 30. Alternatively, a Host may make a Contact Invitation 82. The Contact makes a Decision 84 to accept or decline the Invitation. If the Contact declines to enter into the system, the Contact Exits 78. If the Contact accepts the Invitation, the Contact is entered in the Host's database 30.

Prospecting and Qualifying Activity includes the Host contacting a prospective Member to determine if the individual qualifies to become a Member of the Host's system. The Administrative Activity may occur by any of four (4) paths: Preferral Method, Direct Contact, Indirect Contact, and Online Registration.

The Preferral method for contacting and qualifying a Preferral is by introductory letter and follow-up, or by telephone call. In the case of receiving a Preferral from another Member, the Host would enter the Preferral into the client development system and then direct the program to send an introductory letter. The Host would follow-up by making a telephone call to the Preferral, prompted by the system, shortly thereafter. In addition, the Host may direct the program to remind the Host to perform the initial and subsequent follow-up activities at specific times in the future; or the Host may simply direct the program to remind the Host to call the Preferral when it is more convenient to do so. Thus, a client development system according to the present invention provides a means for automatically scheduling a meeting with, placing a call to, or drafting correspondence to, a Member or Preferral.

In the case of a direct contact with a possible Member, the Host would enter the person into the client development system which would then automatically send the new Member an email welcoming the person into the Host's directory and asking the Member to “opt-in” to receive keep-in-touch emails known as ‘Minute Memos’ which are automatically sent by The Client Machine®, an integral element in this system, in the future. At this time, the preferences of the Member, such as various opt-in selections, are recorded as well.

In the case of an indirect contact with a possible Member, the Host would enter the person into the client development system and would direct the program to send an introductory letter and then remind the Host to make a telephone call to the person shortly thereafter. Alternatively, the Host simply may direct the system to remind the Host to call the possible Member on a specific day and time when it is most convenient for the Host to do so.

In the case where a Member self-registers with a Host via the online Expert Directory webpage provided for that purpose, the client development system would send a confirmation email to the person in order to: (i) welcome the new Member by the HOST; and (ii) ratify the person's intention to receive further contact from the Host in the future (double opt-in). In addition, the client development system also will alert the Host by “flagging” any new Member so that the Host may follow-up at a time and in a manner that is appropriate and convenient for the Host.

As further shown in FIG. 6, each type of output is provided to, or accessed by, a Host. The output typically comprises schedule Calls 44 and Meetings 46, Promises 48, automatic Communications 50, and Reports 52. The client development system further comprises a means for continuous user/Host interface 54.

The step of Contacting and Qualifying a new Member applies to both: (i) new Members who are to be followed-up with as initial contacts; and (ii) existing Members who are to be followed-up with as automatic contacts. Initial contact with new Members is generally made in two (2) basic ways: (i) an introductory letter followed by a telephone call; or (ii) a direct telephone call. The choice is made by the Host when the Member is first entered in to the client development system. Contact with existing Members (“Automatics”) generally involves two (2) basic ways: (i) a “keep-in-touch-stay-in-mind” (“K.I.T.S.I.M.”) telephone call—which is automatically prompted by the client development system on a quarterly basis—as well as (ii) being sent a bi-weekly email (Minute Memo) from the Host. These Members that are to be contacted either initially or automatically are being contacted so that the Host may “qualify” or RE-qualify their suitability to be allowed in, or remain in, the client development system as sources of either (i) revenues, and/or (ii) referrals.

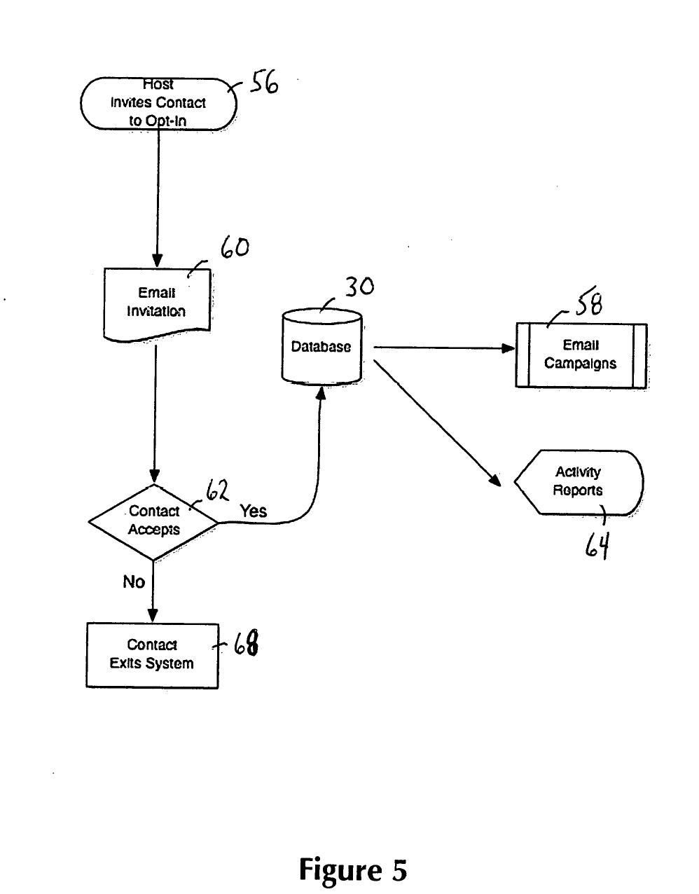

As illustrated in FIG. 5, the process cultivating a Contact begins with the Host inviting a Contact to Opt-In 56 to the Host's Email Campaign by sending the Contact an Email Invitation 60. A Decision 62 is made by the Contact and the Contact either declines and Exits the System 68 or accepts and the information is passed to the Host's database 30. The Contact will then begin receiving the permissioned emails and the Host will receive periodic Activity Reports 64.

With respect to qualifying a Member, the acronym “A.C.T.” describes the only three decisions or “action” that are possible after a Host makes contact with a Member of his or her directory.

“A” stands for activate. A Member that is activated is considered to be someone that may be able to do business with the Host in the near future. These individuals are moved into the “Sales Pipeline” and tracked through it until the Host deems it appropriate to change their status.

“C” stands for cultivate. A Member that qualifies to be cultivated is considered to be someone who is potentially able to provide the Host with business or Preferrals in the future. In other words, they are potential clients or COI's. The relationship has a useful lifetime of value remaining in it (sales or Preferrals) and the HOST wants to be sure to be in the right place at the right time to get their business and Preferrals. Thus, it is imperative that the Host cultivate, or keep-in-touch, with these Members until the Host feels that no further value is likely to be had from further contacts.

These individuals are brought back to the attention of the Host at designated time intervals automatically by the program; once every three months or four times each year. The client development system will also contact these Members on a periodic basis by Minute Memo email and U.S. mail. This status doesn't change once it's made unless the Host changes it or a Member voluntarily leaves the system of a Host. Members that are being cultivated may also be Activated if the Host considers them likely candidates who can possibly do business with the Host in the near future. Whether the Member buys or not, their status in the Host's system remains Cultivate until the Host decides that status is no longer appropriate.

“T” stands for terminate. A Member that, as a result of any contact (initial or automatic), is considered to offer the Host no potential value—sales or Preferrals—in the future is removed from the client development system. This decision means that no further contacts with this individual will be suggested or made by the program. In most cases, the Host will want to retain the Member's contact information for convenient reference should a need ever arise; however, terminated Members hold no further business interest to the Host and no further contact is ordinarily planned for them.

When a Member is entered in the client development system, they are automatically assigned the status of ‘awaiting action’ by the system even if they self-register themselves in a Host's Expert Directory. After a Member is entered into a Host's system or Expert Directory, a Host must decide the status of that Member: Activate, Cultivate, or Terminate.

Prior to an initial contact, a Member's status is, de facto, conditional and the system assigns the status of “Awaiting Action” to that Member unless and until the Host changes it. For example, if a Host enters the contact information about an individual and then directs the client development system to remind the Host to call the person to see what value, if any, the person holds for the Host, and vice versa, the status of the potential Member is not determined by the Host until after that contact is made. The Host is the person responsible for making that determination. However, once that call is completed, then the person's status will be made by the Host: (i) activate if the contact suggests that an active situation is present and the Host will follow-up shortly; (ii) cultivate if some potential is established and the person gives their permission to enter into some plan of the Host for keeping-in-touch; or (iii) terminate if no potential is found. Generally, unless a Member is terminated, the Member's status is Cultivate and, at times, Activate too.

When a Member is being cultivated by the Host's client development system, then three kinds of contacts are required: (i) direct contacts; (ii) indirect contacts; and non-automatic contacts. Direct contacts comprise quarterly keep-in-touch/stay-in-mind telephone calls. These are contacts made directly by the Host. The client development system automatically reminds the Host which Members are to be called and when to place the call.

Any Member in the client development system that is being cultivated should be called. If they are not terminated, they are being cultivated and, as such, qualify to be re-called, on a specified time interval basis, by the Host. In one embodiment of the present invention, the appropriate contact time interval is set at once per quarter, for a total of four (4) times each year. Once the Host determines that a Member holds future value to the Host, the client development system will remind the Host to recall the Member once per quarter for as long as the Host maintains the Member's status as ‘Cultivate’ in the client development system. For example, if a Host initially contacts someone in November and decides to cultivate that Member, the client development system will remind the Host to contact this Member during the months of February, May, August and November until the Host changes the Member's status (‘Terminate’) or the Member ‘opts-out’ of further contact by that Host and directs the system to advise the Host accordingly.

Indirect contacts to Members being cultivated are accomplished through permissioned email distribution, or “opt-in” email distribution. These contacts involve brief bi-weekly emails that are easily read in 15 seconds or less. Such an automatic email distribution system is available within the present invention and is known as The Client Machine™. The Member must opt-in to receive these emails. When the Member completes their registration with the Host's client development system, the Member may choose from various themes such as Sales and Marketing, Home and Family, Health and Wellness, Fun 'N Funky, etc.

The bi-weekly emails serve to maintain a mindfulness of the Host with the Member. This helps keep the Host on the Member's “Mental Shelf” in the Host's provider category (e.g. CPA's, Chiropractors, Attorneys, etc.) and, over time, move the Host up in the ranking of others on that Mental Shelf as the Member perceives it. The bi-weekly emails also remind the Member to visit the Host's Expert Directory and provide an easy means to do so (via hyper link) whenever the Member wants to find an expert whom their Host deems to be both competent and trustworthy enough to risk their reputation with the Member by making an introduction between them.

Once someone is a Member, the client development system reminds the Host to reconnect with them periodically. However, sometimes a need arises to contact a Member at a specific time that is not automatically designed into the program. In those cases, a Host can direct the program to remind the Host to contact the Member at a specific time when it is most appropriate to do so.

When a Member is re-called because the program prompts the Host by an automatic contact, there is always an opportunity that a revenue opportunity may be imminent. When a Host makes a contact with a Member during an automatic recall, the Host may decide to change the Member's opportunity status to Activate. Once activated, the client development system will track the Member's status through the following 6 steps: Meeting Scheduled; Sniff Test; New Fact; Open Case; Decision Meeting, and Disposition.

Meeting Scheduled: a Member agrees to meet with the Host on a specific date/time.

Sniff Test: a Member actually meets with the Host regarding a new opportunity.

New Fact: a Member provides the Host with relevant details about their situation prompting a Host to believe that a revenue opportunity is imminent.

Open Case: a Member with whom the Host has developed the following:

1) Adequate information to justify a recommendation for (buying) action;

2) A proposal or presentation is ordered or prepared to deliver; and

3) A Decision Meeting is scheduled to deliver the recommendation within two weeks.

Decision Meeting: a Member that actually meets with the Host to give a ‘yes’ or ‘no’ decision to a recommendation the Host would like the Member to do.

“Disposition: as a result of a Decision Meeting, a Member can decide to either act on the Host's recommendation or, not. At the same time, the Host can change the Member's status back to Cultivate or Terminate. This allows for a 2×2 matrix of possible dispositions following a Decision Meeting between a Host and Member:
(1) sale/cultivate,
(2) sale/terminate,
(3) no sale/cultivate,
(4) no sale/terminate.”

Each of the above six steps reflect meaningful progress called for by the selling process. As such, these mark the meaningful milestones that must be made as a Member moves closer to a sale.

A client development system according to the present invention provides for further classifying the status of a Member as Sold or Terminated. Clearly, the status of a Member that makes a “yes” decision in a Decision Meeting may be classified as Sold. The status of a Member that, per the Host, has no future business interest or potential may be classified as Terminated. Such status is determined by a Host after putting the Member through the selling pipeline.

In a preferred embodiment of the present invention, the client development system generates personalized emails or hard-copy letters to Preferral sources thanking them for their introductions and informing them of the result of the initial contact with individuals they have referred to or introduced to the Host.

The client development system of the present invention overcomes the shortcomings of the prior art by providing a novel process for identifying an online user's needs and another user's problem-solving capabilities, process steps for contacting such users, qualifying needs and skills, cultivating potential clients, and ultimate disposition of the initial contact. Although the invention has been described in considerable detail with respect to particular embodiments of the Applicant's client development system, it will be apparent that the invention is capable of numerous modifications and variations, apparent to those skilled in the art, without departing from the spirit and scope of the invention.

In the claims:

1. A client development system comprising:
a) a plurality of hosts;
b) a plurality of host databases;
c) identifying a host contact;
d) qualifying the host contact by a host for entry into a host database;
e) periodically interfacing with the contact by the host; and
f) periodically reviewing the qualifications of the host contact by the host for remaining listed in the host's database.

2. The client development system of claim 1 wherein a host database further comprises a plurality of levels of users.

3. The client development system of claim 2 wherein the levels of users comprise the host's level, the host's expert level, and the host's member contact level.

4. The client development system of claim 3 wherein the host's member contact may search the host's expert level for an expert.

5. The client development system of claim 4 wherein the host's member contact may search a plurality of host expert levels of host databases in which the member contact host is listed as an expert.

6. The client development system of claim 3 wherein an expert listed in a host's expert level may search a plurality of host expert levels of host databases.

7. The client development system of claim 1 wherein the step (e) further comprises:
i) inviting the host contact to receive periodic electronic communication;
ii) storing the host contact's response to the invitation; and
iii) periodically electronically distributing the electronic communication to the host contact.

8. The client development system of claim 7 wherein the step (f) further comprises:
i) periodic notice to the host for each host contact whereby the host is directed to take an action; and
ii) periodically updating the host database by the host as a result of the action taken by the host.
